(19) United States
(12) Patent Application Publication
(10) Pub. No.: US 2021/0019724 A1
(43) Pub. Date: Jan. 21, 2021

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Jun UCHIMURA, Tokyo (JP); Hiroshi TAKAHASHI, Kanagawa (JP)

(73) Assignee: NEC Corporation, Minato-ku, Tokyo (JP)

(21) Appl. No.: 16/980,619

(22) PCT Filed: Feb. 22, 2019
(86) PCT No.: PCT/JP2019/006862

§ 371 Date: Sep. 14, 2020

(30) Foreign Application Priority Data
Mar. 19, 2018 (JP) 2018-050927

(51) Int. Cl. G06Q 20/20; G06Q 20/40; G06Q 20/18; G06F 21/60; G06K 7/10; G06K 7/14; G01S 7/481; G01S 17/08

(52) U.S. Cl. CPC G06Q 20/206; G06Q 20/40145; G06Q 20/18; G06F 21/60; G06K 7/10366; G06Q 20/208; G06K 7/1413; G01S 7/4814; G01S 17/08; G06Q 20/204; G06Q 20/201; G06K 7/1417

(57) ABSTRACT

Provided is an information processing system including: an identifying means for identifying a paying person based on a face image; a payment means for accepting payment made by the paying person identified by the identifying means; a detection means for detecting an approaching person who is other than the paying person and comes closer to a payment terminal during the paying person making payment; and a processing means for performing a process for suppressing an action taken by the approaching person when the detection means detects the approaching person.

### TECHNICAL FIELD

The present invention relates to an information processing system, an information processing method, and a storage medium.

### BACKGROUND ART

Patent Literature 1 discloses an information processing system that performs a payment process based on a result of face matching. The information processing system matches face information on a visitor with face information on a paying person and performs a payment process or the like after confirming the visitor and the paying person are the same person.

### CITATION LIST

### Patent Literature

PTL 1: Japanese Patent Application Laid-open No. 2016-126749

### SUMMARY OF INVENTION

### Technical Problem

In the process disclosed in Patent Literature 1, face authentication is performed before payment. However, Patent Literature 1 does not refer to a security problem that may occur during payment after completion of face authentication.

The present invention has been made in view of the problem described above and intends to provide an information processing system, an information processing method, and a storage medium that can further improve security.

### Solution to Problem

According to one example aspect of the present invention, provided is an information processing system including: an identifying means for identifying a paying person based on a face image; a payment means for accepting payment made by the paying person identified by the identifying means; a detection unit that detects an approaching person who is other than the paying person and comes closer to a payment terminal during the paying person making payment; and a processing means for performing a process for suppressing an action taken by the approaching person when the detection means detects the approaching person.

According to another example aspect of the present invention, provided is an information processing method including: identifying a paying person based on a face image; accepting payment made by the identified paying person; detecting an approaching person who is other than the paying person and comes closer to a payment terminal during the paying person making payment; and performing a process for suppressing an action taken by the approaching person when the approaching person is detected.

According to another example aspect of the present invention, provided is a storage medium storing a program that causes a computer to perform: identifying a paying person based on a face image; accepting payment made by the identified paying person; detecting an approaching person who is other than the paying person and comes closer to a payment terminal during the paying person making payment; and performing a process for suppressing an action taken by the approaching person when the approaching person is detected.

### Advantageous Effects of Invention

According to the present invention, it is possible to provide an information processing system, an information processing method, and a storage medium that can further improve security.

### BRIEF DESCRIPTION OF DRAWINGS

FIG. 1 is a block diagram illustrating a general configuration of a POS system according to a first example embodiment.

FIG. 2 is a schematic diagram illustrating the arrangement of a lane in the POS system according to the first example embodiment.

FIG. 3 is a schematic diagram illustrating a general configuration of a face authentication apparatus according to the first example embodiment.

FIG. 4 is a block diagram illustrating a hardware configuration example of an information processing system according to the first example embodiment.

FIG. 5 is a function block diagram of the information processing system according to the first example embodiment.

FIG. 6 is a flowchart illustrating an outline of a process performed by the information processing system according to the first example embodiment.

FIG. 7 is a flowchart illustrating an outline of a process performed by an information processing system according to a second example embodiment.

FIG. 8 is a flowchart illustrating an outline of a process performed by an information processing system according to a third example embodiment.

FIG. 9 is a flowchart illustrating an outline of a process performed by an information processing system according to a fourth example embodiment.

FIG. 10 is a function block diagram of an information processing system according to a fifth example embodiment.

### DESCRIPTION OF EMBODIMENTS

Exemplary example embodiments of the present invention will be described below with reference to the drawings. In the drawings, the same components or corresponding components are labeled with the same reference symbols, and the description thereof may be omitted or simplified.

### First Example Embodiment

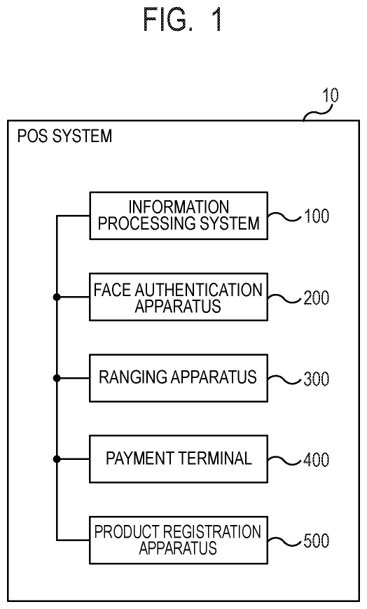

FIG. 1 is a block diagram illustrating a general configuration of a Point Of Sales (POS) system 10 according to the first example embodiment. The POS system 10 is a system that performs registration of a product, payment, or the like for sales of a product or the like in a shop. The POS system 10 includes an information processing system 100, a face authentication apparatus 200, a ranging apparatus 300, a payment terminal 400, and a product registration apparatus 500. The information processing system 100, the face authentication apparatus 200, the ranging apparatus 300, the payment terminal 400, and the product registration apparatus 500 are connected to each other so as to be able to communicate with each other by a wired or wireless manner. Note that the POS system 10 may be used for payment of the price for a provided service.

The information processing system 100 is a computer, for example, and performs processing of control of each apparatus forming the POS system 10, acquisition of information from each apparatus, analysis of acquired information, or the like. The face authentication apparatus 200 is an apparatus that performs face authentication of a visiting customer. The ranging apparatus 300 may be an apparatus such as a stereo camera device, a Light Detection and Ranging (LiDAR) device, or the like and can acquire a spatial distribution of the distance from the ranging apparatus 300 to a ranging target in a predetermined range.

The payment terminal 400 is an apparatus that accepts payment for purchase of a product or the like. This payment may be payment by cash or may be payment by a credit card, a debit card, electronic money, or the like other than cash. To accept payment by cash, a card, or the like, the payment terminal 400 has a cash feeding port, an automatic change machine, a card reader, or the like. Further, the payment terminal 400 has a display device such as a liquid crystal display, an Organic Light Emitting Diode (OLED) display, or the like for display of payment information or the like.

The product registration apparatus 500 is an apparatus that registers a product to be purchased. An amount to be paid at the payment terminal 400 is automatically calculated in the payment terminal 400 in accordance with a registered product. Further, registered product information is stored in a database of the POS system 10 and used for stock management, calculation of proceeds, or the like. Note that the payment terminal 400 and the product registration apparatus 500 may be an integrated apparatus such as a POS register.

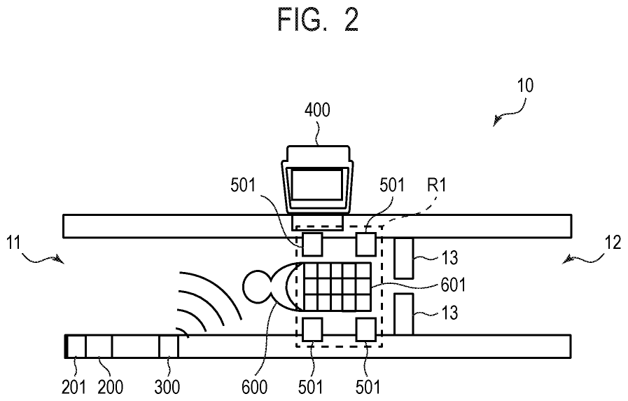

FIG. 2 is a schematic diagram illustrating the arrangement of a lane in a Point of Sales (POS) system 10 according to the first example embodiment. The lane illustrated in FIG. 2 is a self-service type unmanned lane in which a customer 600 performs product registration, payment, or the like by himself/herself. The customer 600 who purchases a product pushes a cart 601 loaded with a product and enters the lane from an entrance 11, and after making payment within the lane, exits from the exit 12.

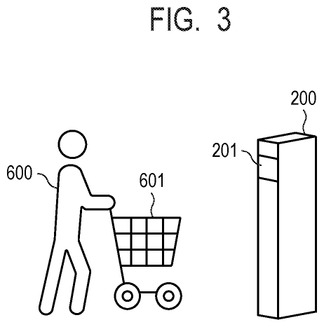

Herein, the configuration of the face authentication apparatus 200 will be described with reference to FIG. 3 in addition. FIG. 3 is a schematic diagram illustrating a general configuration of the face authentication apparatus 200 according to the first example embodiment. The face authentication apparatus 200 has a camera 201. The camera 201 may be arranged near a height of a face the customer 600 so that the face of the customer 600 is included in a capturing range. When the customer 600 comes closer to the entrance 11 while pushing the cart 601, the camera 201 of the face authentication apparatus 200 captures an image of the face of the customer 600 and acquires a face image. The face authentication apparatus 200 calculates a feature amount used for matching from the face image. The face authentication apparatus 200 performs authentication of the customer 600 by matching the calculated feature amount with a feature amount of a face pre-registered in an authentication server. In such a way, the customer 600 authenticated based on a face image is identified as a paying person who permits payment using the POS system 10.

Note that, when the face image of the visiting customer 600 does not match any of the registered face images, when a feature amount is not extracted because a part of the face is hidden, or the like, the authentication of the customer 600 may fail. In such a case, the POS system 10 may perform display to the effect that payment on the lane is not permitted or the like. Further, in addition to the above, the POS system 10 may perform a process of guiding the customer to a manned lane where a salesclerk stands by or the like.

Once the customer 600 is identified as a paying person by the face authentication, the customer 600 pushes the cart 601 to go ahead in the lane and moves the cart 601 up to a position where product registration can be performed. In the present example embodiment, an integrated circuit (IC) tag based on a Radio Frequency Identifier (RFID) technology is attached to each product loaded on the cart 601. A storage medium included in an IC tag stores product identification information. The product registration apparatus 500 has at least one wireless communication terminal 501 adapted to the RFID technology. The wireless communication terminal 501 is an antenna device based on the RFID technology, for example. The wireless communication terminal 501 acquires product identification information on each product on the cart 601 by wirelessly communicating with the IC tag. Thereby, the product registration apparatus 500 can register a product loaded on the cart 601 by the customer 600. A communication coverage region R1 illustrated in FIG. 2 indicates a range in which an IC tag mounted on the cart 601 can be read by any of the plurality of wireless communication terminals 501. In the example of FIG. 2, to secure a readable range corresponding to the shape of the cart 601, four wireless communication terminals 501 are arranged so as to form a rectangle.

Note that acquisition of product identification information may be performed by using a scanner or the like to read a code attached to a package of a product or the like, such as a barcode, a two-dimensionally code, or the like.

Once the product registration apparatus 500 acquires product identification information, information such as a product name, a quantity of products, or payment amount of a payment target, the name of the customer 600, a number of a credit card or the like that can be used for payment, or an operation instruction to a customer 600 is displayed on the display device of the payment terminal 400.

Note that information related to a product of a payment target out of the displayed information can be acquired from a product database in the POS system 10 based on product identification information. The information related to the customer 600 can be acquired from a customer database in the POS system 10 based on a result of face authentication.

While the customer 600 is performing a payment procedure, the ranging apparatus 300 performs ranging within a predetermined ranging range including the payment terminal 400. Accordingly, the arrangement such that a person comes closer to the payment terminal 400 is included in the ranging range is realized. For example, this ranging may be three-dimensional measurement to measure the distance in the depth direction while scanning two directions of the vertical direction and the horizontal direction. In such a case, three-dimensional information within the range including the payment terminal 400 can be obtained. Note that, when the ranging apparatus 300 is a LiDAR device, the ranging accuracy in the depth direction can be improved compared to the case where a stereo camera or the like is employed. Although the type of a laser light source used for the LiDAR device is not particularly limited, the case where the laser light source is a laser light source that emits invisible light such as an infrared ray is more preferable because the ranging light does not give discomfort to the customer 600. The method of utilizing the information acquired by the ranging apparatus 300 will be described later.

In response to the customer 600 completing payment using the payment terminal 400, the POS system 10 operates to open gates 13. The customer 600 then pushes the cart 601 loaded with a paid product and exits from the exit 12.

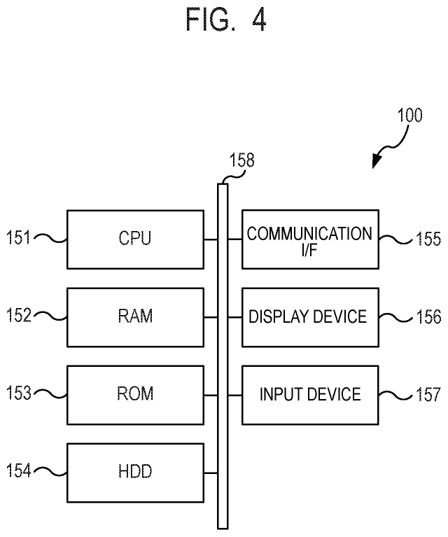

Next, the configuration and the operation of the information processing system 100 will be described. FIG. 4 is a block diagram illustrating an example of a hardware configuration of the information processing system 100. The information processing system 100 may be a computer, for example. The information processing system 100 may be a computer provided inside the face authentication apparatus 200, the ranging apparatus 300, the payment terminal 400, or the product registration apparatus 500.

The information processing system 100 has a central processing unit (CPU) 151, a random access memory (RAM) 152, a read only memory (ROM) 153, and a hard disk drive (HDD) 154 as a computer that performs calculation, control, and storage. The information processing system 100 further has a communication interface (I/F) 155, a display device 156, and an input device 157. The CPU 151, the RAM 152, the ROM 153, the HDD 154, the communication I/F 155, the display device 156, and the input device 157 are connected to each other via a bus 158. Note that the display device 156 and the input device 157 may be connected to the bus 158 via a drive device (not illustrated) used for driving these devices.

While respective components forming the information processing system 100 are illustrated as an integrated device in FIG. 4, some of these functions may be provided by an external device. For example, the display device 156 and the input device 157 may be an external device independent of a part forming the function of a computer including the CPU 151 and the like.

The CPU 151 has a function of performing a predetermined operation in accordance with a program stored in the ROM 153, the HDD 154, or the like and also controlling each component of the information processing system 100. The RAM 152 is formed of a volatile storage medium and provides a temporary memory area necessary for the operation of the CPU 151. The ROM 153 is formed of a nonvolatile storage medium and stores necessary information such as a program used for the operation of the information processing system 100. The HDD 154 is a storage device that is formed of a nonvolatile storage medium and stores data required for processing, a program for operating the information processing system 100, or the like.

The communication I/F 155 is a communication interface based on the specification such as Ethernet (registered trademark), Wi-Fi (registered trademark), 4G, or the like, which is a module used for communicating with other devices. The display device 156 is a liquid crystal display, an OLED display, or the like and is used for displaying an image, a text, an interface, or the like. The input device 157 is a keyboard, a pointing device, or the like and is used by the user for operating the information processing system 100. An example of the pointing device may be a mouse, a trackball, a touch panel, or the like. The display device 156 and the input device 157 may be integrally formed as a touch panel.

Note that the hardware configuration illustrated in FIG. 4 is an example, and a device other than the above may be added, or some of the devices may not be provided. Further, some of the devices may be replaced with another device having the same function. Furthermore, a part of the function of the present example embodiment may be provided by another device via a network, or the function of the present example embodiment may be implemented by being distributed in a plurality of devices. For example, the HDD 154 may be replaced with a solid state drive (SSD) using a semiconductor memory or may be replaced with cloud storage.

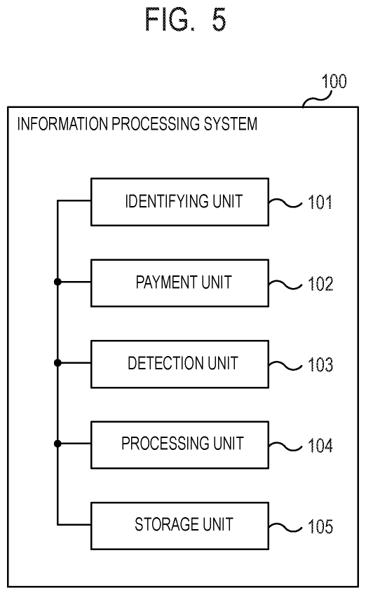

FIG. 5 is a function block diagram of the information processing system 100 according to the present example embodiment. The information processing system 100 has an identifying unit 101, a payment unit 102, a detection unit 103, a processing unit 104, and a storage unit 105.

The CPU 151 implements functions of the identifying unit 101, the payment unit 102, the detection unit 103, and the processing unit 104 by loading a program stored in the ROM 153, the HDD 154, or the like to the RAM 152 and executing the program. Processes performed in these units will be described later. The CPU 151 implements a function of the storage unit 105 by controlling the HDD 154.

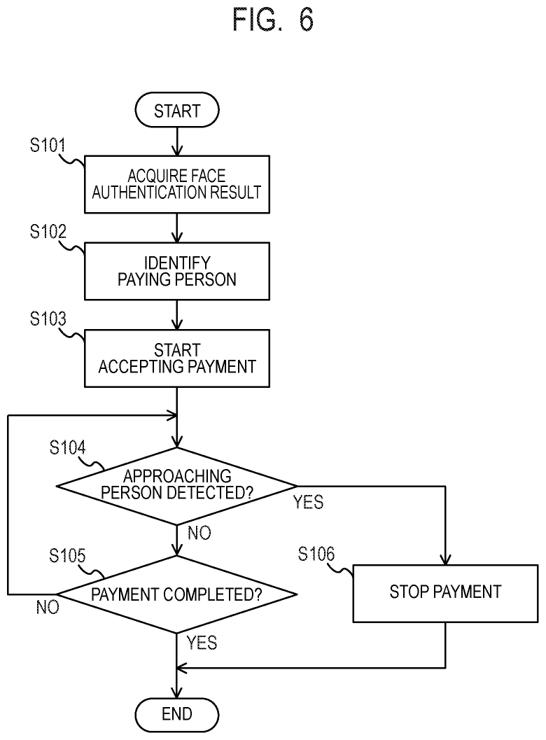

FIG. 6 is a flowchart illustrating a process performed by the information processing system 100 according to the present example embodiment. A payment-related process performed by the information processing system 100 will be described with reference to FIG. 6.

In step S101, the information processing system 100 acquires information related to a result of face authentication performed by the face authentication apparatus 200. The information related to the acquired face authentication result is stored in the storage unit 105. Further, if necessary, a face image of the customer 600 or a feature amount calculated form the face image may be further acquired and stored in the storage unit 105.

In step S102, the identifying unit 101 identifies a paying person who permits acceptance of payment on the payment terminal 400 based on information related to face authentication stored in the storage unit 105.

In step S103, the payment unit 102 controls the payment terminal 400 and the product registration apparatus 500 so that the paying person identified by the identifying unit 101 can make payment. This enables the customer 600 to start product registration with the product registration apparatus 500 and payment with the payment terminal 400.

After starting accepting payment in step S103, the information processing system 100 instructs the ranging apparatus 300 to range a range including the payment terminal 400 in step S104. The distance information acquired by this ranging is transmitted to the information processing system 100 and stored in the storage unit 105 if necessary. The detection unit 103 analyzes the distance information to detect an approaching person who is other than the paying person and comes closer to the payment terminal 400 while the paying person is making payment.

Herein, the approaching person refers to a person who is other than a paying person and its companion and comes closer to the payment terminal 400 after the paying person was identified in step S102. A typical example of the approaching person may be a person who attempts to impersonate a paying person to operate the payment terminal 400, a person who attempts to peek into the display screen of the payment terminal 400 to acquire information, a person who attempts to steel money or the like possessed by a paying person, or the like.

A specific example of such a detection process may be a process using a scheme to analyze whether or not a person at a distance to the payment terminal 400 that is less than or equal to a predetermined threshold is present other than a paying person.

In step S104, if the detection unit 103 detects an approaching person who is other than a paying person and comes closer to the payment terminal 400 (step S104, YES), the process proceeds to steps S106. In step S104, if the detection unit 103 does not detect an approaching person who is other than a paying person and comes closer to the payment terminal 400 (step S104, NO), the process proceeds to steps S105.

In step S105, the information processing system 100 detects the process status in the payment terminal 400 and the product registration apparatus 500 and determines whether or not payment is completed. If the payment is completed (step S105, YES), this process ends. If the payment is not completed (step S105, NO), the process proceeds to step S104 and continues detection of an approaching person.

In step S106, the processing unit 104 performs a process for stopping the payment on the payment terminal 400 and the product registration apparatus 500. Accordingly, it is possible to suppress an approaching person from impersonating the paying person and making payment.

According to the present example embodiment, while a paying person is making payment, it is possible to suppress impersonated payment that is one of the security problems that may occur when a person other than the paying person approaches the payment terminal 400. Accordingly, an information processing system that can further improve security is provided.

Note that the likelihood of impersonated payment may no longer exists when the approaching person leaves the payment terminal 400 after step S106 or the like. In such a case, the processing unit 104 may perform a process of resuming payment on the payment terminal 400 and the product registration apparatus 500.

### Second Example Embodiment

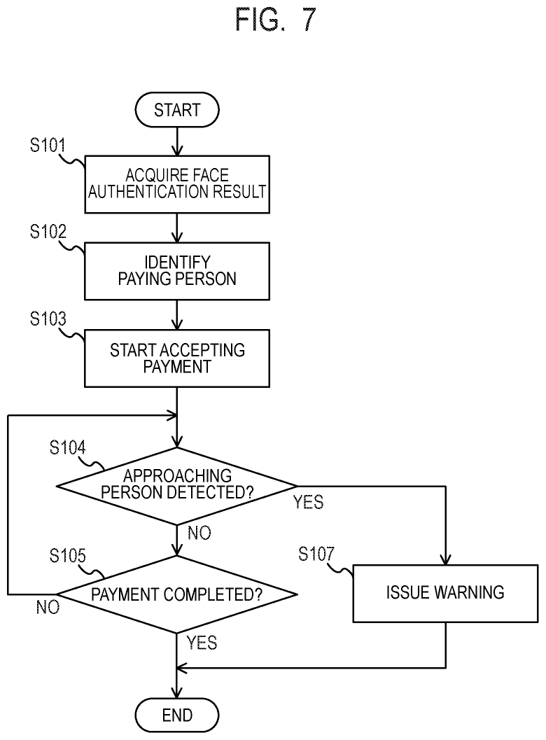

FIG. 7 is a flowchart illustrating a process performed by the information processing system 100 according to the present example embodiment. A payment-related process performed by the information processing system 100 will be described with reference to FIG. 7. Note that, in the description of the present example embodiment, the description of a part duplicated with the first example embodiment will be omitted or simplified.

The POS system 10 of the present example embodiment has a warning apparatus. The warning apparatus is an apparatus that issues a warning to a person nearby, a manager of the POS system 10, a guard, or the like by using a sound, light, a voice, or the like. In step S107, the processing unit 104 performs a process of causing the warning apparatus provided to the POS system 10 to issue a warning. The content of such a warning may be, for example, a message that urges an approaching person to stay away from the payment terminal 400. Alternatively, the content of such a warning may be a content to notify a paying person of the presence of an approaching person and alert the paying person. Accordingly, it is possible to solve the security problem due to the presence of an approaching person, and an information processing system that can further improve security is provided.

### Third Example Embodiment

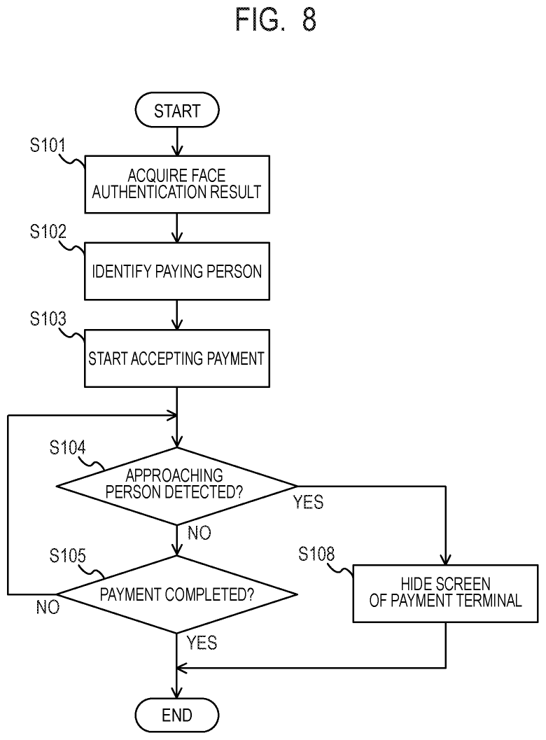

FIG. 8 is a flowchart illustrating a process performed by the information processing system 100 according to the present example embodiment. A payment-related process performed by the information processing system 100 will be described with reference to FIG. 8. Note that, in the description of the present example embodiment, the description of a part duplicated with the first example embodiment or the second example embodiment will be omitted or simplified.

The payment terminal 400 of the present example embodiment has a function of hiding a screen of a display device in accordance with control from the processing unit 104 of the information processing system 100. In step S108, the processing unit 104 performs a process of hiding the screen of the display device provided to the payment terminal 400. The payment terminal 400 may display personal information on a paying person, such as shopping information on a paying person, the name of a paying person, a credit card number of a paying person, or the like. In the present example embodiment, by hiding the screen when an approaching person is detected, it is possible to prevent peeking of payment information. Therefore, an information processing system that can further improve security is provided.

Note that, while the process of hiding described above may cause the overall screen to be hidden, only a part of information such as personal information on a paying person in a screen may be hidden.

Note that, even when the process of the present example embodiment is employed, a case where payment information may be peeked from the outside of the ranging range of the ranging apparatus 300, such as the entrance or the exit of a lane is expected. To prevent such peeking from a distance place, a mechanism for preventing peeking from an angle other than the front by using a scheme of providing an anti-peek filter on the display screen of the payment terminal 400, providing a partition to the side of the display screen, or the like may be added to a display screen.

### Fourth Example Embodiment

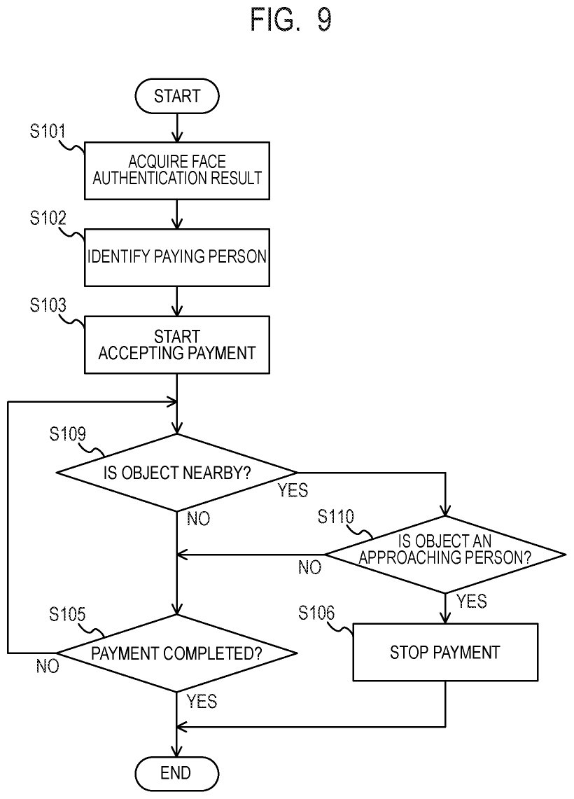

FIG. 9 is a flowchart illustrating a process performed by the information processing system 100 according to the present example embodiment. A payment-related process performed by the information processing system 100 will be described with reference to FIG. 9. Note that, in the description of the present example embodiment, the description of a part duplicated with the first example embodiment to the third example embodiment will be omitted or simplified.

The detection unit 103 of the present example embodiment has a function of detecting an approaching person by determining whether or not an object present near a paying person is an approaching person. In step S109, the detection unit 103 determines whether or not an object is present near the payment terminal 400 based on distance information. If the detection unit 103 determines that an object is present near the payment terminal 400 (step S109, YES), the process proceeds to step S110. If the detection unit 103 determines that no object is present near the payment terminal 400 (step S109, NO), the process proceeds to step S105.

In step S110, the detection unit 103 determines whether or not the object present near the payment terminal 400 is an approaching person. If the detection unit 103 determines that the object present near the payment terminal 400 is an approaching person (step S110, YES), the process proceeds to step S106. If the detection unit 103 determines that the object present near the payment terminal 400 is not an approaching person (step S110, NO), the process proceeds to step S105.

Several specific examples will be described for the determination scheme in step S110. The detection unit 103 can determine the type of the object based on the shape of the object obtained by the ranging apparatus 300 by using an image recognition technology and determine whether or not the object is an approaching person. For example, when the object is an object other than a human, such as the cart 601, an animal, or the like, it may be determined that the object is not an approaching person.

Further, in another example, the detection unit 103 can determine whether or not the object is an approaching person based on whether or not the size of the object obtained by the ranging apparatus 300 is within a predetermined range. For example, it is possible to exclude a child from the approaching person by determining that the object is an approaching person if the size of the object is within a range of an adult human and otherwise, determining that the object is not an approaching person.

Further, in another example, the detection unit 103 can determine that the object is not an approaching person when the object has been present near the payment terminal 400 since a point of time when the identifying unit 101 identified the paying person for the first time. This is because a person or an object that has been present near a paying person before payment is started is considered to be a companion or a possession of the paying person. Accordingly, it is possible to exclude a companion or a possession of a paying person from the approaching person.

In the present example embodiment, the process of step S106 is performed after it is determined by the process of step S109 and step S110 whether or not the object present near the payment terminal 400 is an approaching person. Accordingly, it is possible to reduce the possibility that an object that does not cause a security problem, such as an object other than a human, a companion of a paying person, or the like, is erroneously detected as an approaching person.

Note that step S106 of the present example embodiment may be replaced with step S107 of the second example embodiment or step S108 of the third example embodiment.

The system described in the above example embodiment can also be configured as the following fifth example embodiment.

### Fifth Example Embodiment

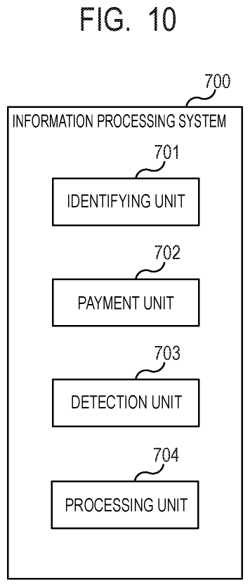

FIG. 10 is a function block diagram of an information processing system 700 according to the fifth example embodiment. The information processing system 700 has an identifying unit 701, a payment unit 702, a detection unit 703, and a processing unit 704. The identifying unit 701 identifies a paying person based on a face image. The payment unit 702 accepts payment made by the paying person identified by the identifying unit 701. The detection unit 703 detects an approaching person who is other than the paying person and comes closer to a payment terminal during the paying person making payment. The processing unit 704 performs a process for suppressing an action taken by the approaching person when the detection unit detects the approaching person.

According to the present example embodiment, the information processing system 700 that can further improve security is provided.

### Modified Example Embodiment

The present invention is not limited to the example embodiments described above and can be changed as appropriate without departing from the spirit of the present invention.

Although the specific examples of the process performed by the processing unit 104 when an approaching person is detected have been illustrated in the first to third example embodiments, the example is not limited thereto. The process performed by the processing unit 104 when an approaching person is detected may be another process than is illustrated as example as long as it suppresses an action taken by the approaching person.

In the example embodiments described above, the ranging apparatus 300 may be replaced with an apparatus that does not perform ranging, such as a still camera, a video camera, or the like. In such a case, it is possible to calculate a distance between the payment terminal 400 and an approaching person from a captured image by using various image analysis technologies and perform the same process based on the calculated distance. However, it is more desirable to employ the ranging apparatus 300 that can directly measure a distance.

Further, although information obtained by the ranging apparatus 300 is used for detection of an approaching person in the example embodiments described above, detection is not limited thereto. For example, the face authentication apparatus 200 may detect an approaching person. The detection of approaching person in accordance with face authentication may be performed as follows. The camera 201 provided to the face authentication apparatus 200 acquires one or more face images of one or a plurality of persons present within a predetermined range near the payment terminal 400 during the paying person making payment. When there is a face image which does not match the face image of the paying person out of the one or more face images of persons, the face authentication apparatus 200 detects the corresponding person as an approaching person. An approaching person can be detected by this scheme in the same manner as in the case of example embodiments described above. Further, a use of a face authentication technology reduces the likelihood of a paying person being erroneously recognized as an approaching person.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may be a circuit such as an application specific integrated circuit (ASIC), a field programmable gate array (FPGA), or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

Further, a service implemented by the function of each of the example embodiments described above may be provided to a user in a form of Software as a Service (SaaS).

Note that all the example embodiments described above are mere embodied examples in implementing the present invention, and the technical scope of the present invention should not be construed in a limiting sense by these example embodiments. That is, the present invention can be implemented in various forms without departing from the technical concept thereof or the primary feature thereof.

The whole or part of the example embodiments disclosed above can be described as, but not limited to, the following supplementary notes.

### (Supplementary Note 1)

An information processing system comprising:

an identifying means for identifying a paying person based on a face image;

a payment means for accepting payment made by the paying person identified by the identifying means;

a detection means for detecting an approaching person who is other than the paying person and comes closer to a payment terminal during the paying person making payment; and

a processing means for performing a process for suppressing an action taken by the approaching person when the detection means detects the approaching person.

### (Supplementary Note 2)

The information processing system according to supplementary note 1, wherein the processing means stops payment performed by the payment means when the detection means detects the approaching person.

### (Supplementary Note 3)

The information processing system according to supplementary note 1 or 2, wherein the processing means issues a warning when the detection means detects the approaching person.

### (Supplementary Note 4)

The information processing system according to any one of supplementary notes 1 to 3,

wherein the payment terminal comprises a display device that displays information related to payment made by the paying person, and

wherein the processing means hides a part or a whole of information displayed on the display device when the detection means detects the approaching person.

### (Supplementary Note 5)

The information processing system according to any one of supplementary notes 1 to 4, wherein the detection means detects the approaching person based on distance information acquired by a ranging apparatus that acquires a distance to a ranging target.

### (Supplementary Note 6)

The information processing system according to supplementary note 5, wherein the ranging apparatus is arranged such that the payment terminal is included in a ranging range.

### (Supplementary Note 7)

The information processing system according to supplementary note 5 or 6, wherein the ranging apparatus includes a Light Detection and Ranging (LiDAR) device.

### (Supplementary Note 8)

The information processing system according to supplementary note 7, wherein the LiDAR device includes a laser light source that emits invisible light.

### (Supplementary Note 9)

The information processing system according to any one of supplementary notes 1 to 4, wherein the detection means acquires a face image of a person present again within a predetermined range during the paying person making payment and, when a face image of the person and a face image of the paying person are not matched, detects the person as the approaching person.

### (Supplementary Note 10)

The information processing system according to any one of supplementary notes 1 to 9, wherein the detection means detects the approaching person by determining whether or not an object present near the payment terminal is the approaching person.

### (Supplementary Note 11)

The information processing system according to supplementary note 10, wherein the detection means determines whether or not the object is the approaching person based on a shape of the object.

### (Supplementary Note 12)

The information processing system according to supplementary note 10 or 11, wherein the detection means determines that the object is the approaching person when a size of the object is within a predetermined range.

### (Supplementary Note 13)

The information processing system according to any one of supplementary notes 10 to 12, wherein the detection means determines that the object is not the approaching person when the object has been present near the payment terminal since a point of time when the identifying means identified the paying person for the first time.

### (Supplementary Note 14)

An information processing method comprising:

identifying a paying person based on a face image;

accepting payment made by the identified paying person;

detecting an approaching person who is other than the paying person and comes closer to a payment terminal during the paying person making payment; and

performing a process for suppressing an action taken by the approaching person when the approaching person is detected.

### (Supplementary Note 15)

A storage medium storing a program that causes a computer to perform:

identifying a paying person based on a face image;

accepting payment made by the identified paying person;

detecting an approaching person who is other than the paying person and comes closer to a payment terminal during the paying person making payment; and

performing a process for suppressing an action taken by the approaching person when the approaching person is detected.

This application is based upon and claims the benefit of priority from Japanese Patent Application No. 2018-050927, filed on Mar. 19, 2018, the disclosure of which is incorporated herein in its entirety by reference.

### REFERENCE SIGNS LIST

10 POS system
11 entrance
12 exit
13 gate
100, 700 information processing system
101, 701 identifying unit
102, 702 payment unit
103, 703 detection unit
104, 704 processing unit
105 storage unit
151 CPU
152 RAM
153 ROM
154 HDD
155 communication I/F
156 display device
157 input device
158 bus
200 face authentication apparatus
201 camera
300 ranging apparatus
400 payment terminal
500 product registration apparatus
501 wireless communication terminal
600 customer
601 cart
R1 communication coverage region

What is claimed is:

1. An information processing system comprising:
an identifying unit that identifies a paying person based on a face image;
a payment unit that accepts payment made by the paying person identified by the identifying unit;
a detection unit that detects an approaching person who is other than the paying person and comes closer to a payment terminal during the paying person making payment; and
a processing unit that performs a process for suppressing an action taken by the approaching person when the detection unit detects the approaching person.

2. The information processing system according to claim 1, wherein the processing unit stops payment performed by the payment unit when the detection unit detects the approaching person.

3. The information processing system according to claim 1, wherein the processing unit issues a warning when the detection unit detects the approaching person.

4. The information processing system according to claim 1,
wherein the payment terminal comprises a display device that displays information related to payment made by the paying person, and
wherein the processing unit hides a part or a whole of information displayed on the display device when the detection unit detects the approaching person.

5. The information processing system according to claim 1, wherein the detection unit detects the approaching person based on distance information acquired by a ranging apparatus that acquires a distance to a ranging target.

6. The information processing system according to claim 5, wherein the ranging apparatus is arranged such that the payment terminal is included in a ranging range.

7. The information processing system according to claim 5, wherein the ranging apparatus includes a Light Detection and Ranging (LiDAR) device.

8. The information processing system according to claim 7, wherein the LiDAR device includes a laser light source that emits invisible light.

9. The information processing system according to claim 1, wherein the detection unit acquires a face image of a person present again within a predetermined range during the paying person making payment and, when a face image of the person and a face image of the paying person are not matched, detects the person as the approaching person.

10. The information processing system according to claim 1, wherein the detection unit detects the approaching person by determining whether or not an object present near the payment terminal is the approaching person.

11. The information processing system according to claim 10, wherein the detection unit determines whether or not the object is the approaching person based on a shape of the object.

12. The information processing system according to claim 10, wherein the detection unit determines that the object is the approaching person when a size of the object is within a predetermined range.

13. The information processing system according to claim 10, wherein the detection unit determines that the object is not the approaching person when the object has been present near the payment terminal since a point of time when the identifying unit identified the paying person for the first time.

14. An information processing method comprising:
identifying a paying person based on a face image;
accepting payment made by the identified paying person;
detecting an approaching person who is other than the paying person and comes closer to a payment terminal during the paying person making payment; and
performing a process for suppressing an action taken by the approaching person when the approaching person is detected.

15. A non-transitory storage medium storing a program that causes a computer to perform:
identifying a paying person based on a face image;
accepting payment made by the identified paying person;
detecting an approaching person who is other than the paying person and comes closer to a payment terminal during the paying person making payment; and
performing a process for suppressing an action taken by the approaching person when the approaching person is detected.
